(19) United States
(12) Patent Application Publication
(10) Pub. No.: US 2018/0231118 A1
(43) Pub. Date: Aug. 16, 2018

(54) WORK MACHINE

(71) Applicant: Komatsu Ltd., Tokyo (JP)

(72) Inventor: Shinji Kaneko, Tokyo (JP)

(73) Assignee: Komatsu Ltd., Tokyo (JP)

(21) Appl. No.: 15/511,342

(22) PCT Filed: Nov. 11, 2016
(86) PCT No.: PCT/JP2016/083607

§ 371 Date: Mar. 15, 2017

(51) Int. Cl. F16H 61/4017; F16H 61/478; F16H 61/421; F16H 61/4035

(52) U.S. Cl. CPC F16H 61/4017; F16H 61/478; B66F 9/04; F16H 61/4035; F16H 61/421

(57) ABSTRACT

A work machine includes a relief valve that is installed in a hydraulic line that forms a closed circuit between a hydraulic pump and a hydraulic motor, and sets a relief pressure of the hydraulic line; a braking device that brakes a traveling device attached to the hydraulic motor; and an operation mechanism that operates the braking device. When a traveling speed of the traveling device is equal to or more than a predetermined threshold, the relief pressure is changed from a first pressure that is a pressure before a braking operation is performed by the operation mechanism to a second pressure that is lower than the first pressure.

### FIELD

The present invention relates to a work machine that includes a hydraulic pump and a hydraulic motor that forms a closed circuit with the hydraulic pump and is driven by hydraulic oil discharged from the hydraulic pump.

### BACKGROUND

There is a work machine that includes a hydraulic driving device called a hydro sratic transmission (HST) between an engine as a driving source and a driving wheel. The HST is provided with, in a main hydraulic circuit which is a closed circuit, a variable displacement traveling hydraulic pump which is driven by the engine and a variable displacement hydraulic motor which is driven by hydraulic oil discharged from the traveling hydraulic pump, and causes a vehicle to travel by transmitting a driving force of the hydraulic motor to the driving wheel.

A hydraulic circuit is typically provided with a relief valve which discharges hydraulic oil when becoming a predetermined pressure in order to prevent the generation of an excessive pressure. The same applies to the main hydraulic circuit included in the HST. Patent Literature 1 describes a relief valve whose set pressure is changeable.

### CITATION LIST

### Patent Literature

Patent Literature 1: JP 2014-25209 A

### SUMMARY

### Technical Problem

Typically, a work machine includes a mechanical brake. The same applies to the work machine that includes the HST. During braking of the work machine that includes the HST, the flow rate of the traveling hydraulic pump is reduced to generate a braking force. Simultaneously, the mechanical brake also generates a braking force. Due to a response delay of the traveling hydraulic pump, an excessive pressure may be generated in hydraulic oil inside the main hydraulic circuit during braking of the work machine that includes the HST.

It is an object of an aspect of the present invention to prevent an excessive rise in the pressure of hydraulic oil inside a main hydraulic circuit during braking of a work machine provided with an HST.

### Solution to Problem

According to a first aspect of the present invention, a work machine comprises: a relief valve that is installed in a hydraulic line that forms a closed circuit between a hydraulic pump and a hydraulic motor, and sets a relief pressure of the hydraulic line; a braking device that brakes a traveling device attached to the hydraulic motor; and an operation mechanism that operates the braking device, wherein when a traveling speed of the traveling device is equal to or more than a predetermined threshold, the relief pressure is changed from a first pressure that is a pressure before a braking operation is performed by the operation mechanism to a second pressure that is lower than the first pressure.

According to a second aspect of the present invention, in the work machine according to the aspect 1, wherein the relief pressure is changed from the second pressure to the first pressure after continuation of a reduced state of an operation amount of the braking operation applied to the operation mechanism for a predetermined time.

According to a third aspect of the present invention, a work machine comprises a relief valve that is installed in a hydraulic line that forms a closed circuit between a hydraulic pump and a hydraulic motor, and sets a relief pressure of the hydraulic line, wherein the relief pressure is changed according to at least either a state of an electrical system between a control device that controls the hydraulic pump and the hydraulic motor and the hydraulic pump or a state of an electrical system between the control device and the hydraulic motor.

According to a fourth aspect of the present invention, in the work machine according to any one of the aspects 1 to 3, wherein the relief valve is capable of steplessly changing the relief pressure.

The aspects of the present invention make it possible to prevent an excessive rise in the pressure of hydraulic oil inside the main hydraulic circuit during braking of the work machine provided with the HST.

### BRIEF DESCRIPTION OF DRAWINGS

FIG. 1 illustrates the entire configuration of a forklift which is an example of a work machine according to an embodiment.

FIG. 2 is a block diagram illustrating a control system of the forklift illustrated in FIG. 1.

FIG. 3 is a flowchart illustrating a control example of the forklift during braking.

FIG. 4 is a flowchart illustrating a processing example under an abnormal condition of an electrical system.

FIG. 5 is a diagram illustrating an example of steplessly changing a relief pressure of a relief valve.

### DESCRIPTION OF EMBODIMENTS

Hereinbelow, an embodiment for carrying out the invention will be described with reference to the accompanying drawings.

<Forklift>

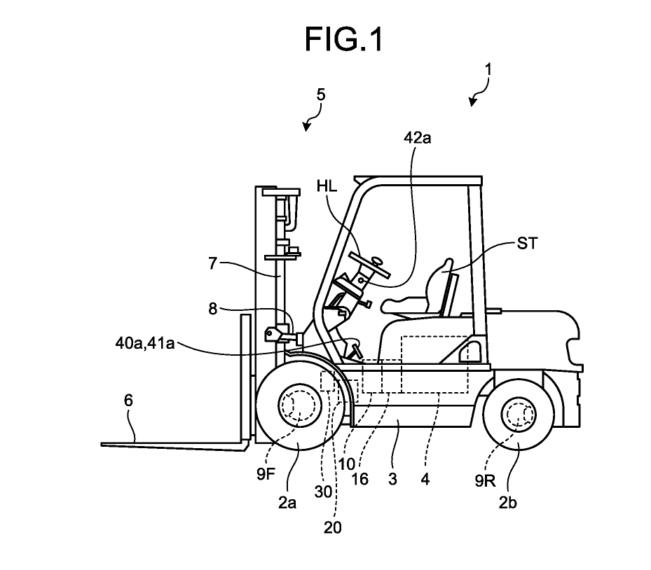

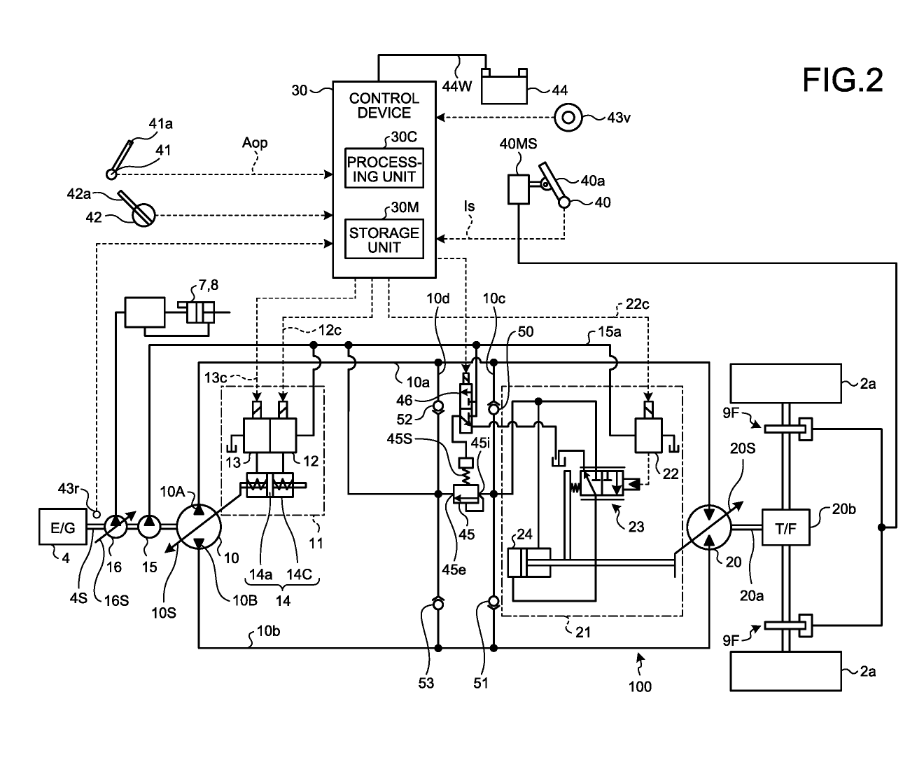

FIG. 1 illustrates the entire configuration of a forklift 1 which is an example of a work machine according to the embodiment. FIG. 2 is a block diagram illustrating a control system of the forklift 1 illustrated in FIG. 1. The forklift 1 includes a vehicle body 3 which includes a driving wheel 2a and a steering wheel 2b, a work device 5, and mechanical brakes 9F, 9R which are braking devices for braking the driving wheel 2a and the steering wheel 2b. In the forklift 1, a side from a driver's seat ST toward a steering member HL is a forward side, and a side from the steering member HL toward the driver's seat ST is a backward side. The work device 5 is disposed on the front side of the vehicle body 3.

The vehicle body 3 is equipped with an engine 4 which is an example of an internal combustion engine, and a traveling hydraulic pump 10 and a work device hydraulic pump 16 which are variable displacement hydraulic pumps driven using the engine 4 as a driving source. The engine 4 is, for example, a diesel engine, but not limited thereto. An output shaft 4S of the engine 4 is coupled to the work device hydraulic pump 16. The work device hydraulic pump 16 and the traveling hydraulic pump 10 are coupled to each other through a charge pump 15. The traveling hydraulic pump 10, the work device hydraulic pump 16, and the charge pump 15 are driven by the engine 4 through the output shaft 4S and discharge hydraulic oil.

A hydraulic motor 20 is mounted on the vehicle body 3. The hydraulic motor 20 is a variable displacement hydraulic motor. The hydraulic motor 20 forms a closed circuit through which hydraulic oil flows with the traveling hydraulic pump 10. The hydraulic motor 20 is driven by hydraulic oil discharged from the traveling hydraulic pump 10 and rotates the driving wheel 2a as a vehicle wheel. The driving wheel 2a is driven by power generated by the hydraulic motor 20.

The variable displacement traveling hydraulic pump 10 and the variable displacement hydraulic motor 20 communicate with each other through a closed circuit, that is, a closed hydraulic circuit and form an HST. In this manner, the forklift 1 travels by the HST. In the embodiment, the traveling hydraulic pump 10 includes a swash plate 10S and the work device hydraulic pump 16 includes a swash plate 16S, and a displacement is changed by changing tilt angles of the swash plate 10S and the swash plate 16S.

The work device 5 includes a lift cylinder 7 which raises and lowers a fork 6 on which a load is placed and a tilt cylinder 8 which tilts the fork 6. A forward/reverse lever 42a, an inching pedal 40a as a brake operating unit, an accelerator pedal 41a as an accelerator operating unit, and a work device operating lever for operating the work device 5 are provided around the driver's seat of the vehicle body 3. The inching pedal 40a is also called a brake pedal.

The inching pedal 40a changes an inching rate. The accelerator pedal 41a changes a fuel supply amount to the engine 4. The inching pedal 40a and the accelerator pedal 41a are disposed at positions that enable an operator of the forklift 1 to operate the inching pedal 40a and the accelerator pedal 41a with his/her foot from the driver's seat. FIG. 1 illustrates the inching pedal 40a and the accelerator pedal 41a in an overlapping state.

The inching pedal 40a is an operation mechanism which operates the mechanical brakes 9F, 9R. That is, when the inching pedal 40a is operated, a brake oil is supplied to the mechanical brakes 9F, 9R from a master cylinder 40MS illustrated in FIG. 2. Upon the supply of the brake oil, the mechanical brakes 9F, 9R generate a braking force to the driving wheel 2a and the steering wheel 2b by pressure of the supplied brake oil.

In the embodiment, since the work machine is the forklift 1, a traveling device of the work machine is the vehicle wheel of the forklift 1, more specifically, the driving wheel 2a. As illustrated in FIG. 2, the driving wheel 2a is attached to the hydraulic motor 20 through an output shaft 20a and a transfer 20b. For example, in the case of a work machine provided with a crawler such as a bulldozer, a traveling device is the crawler. Although the traveling device differs depending on the type of the work machine, any device that causes the work machine to travel may be employed.

<Main Hydraulic Circuit 100>

As illustrated in FIG. 2, the forklift 1 is provided with a main hydraulic circuit 100. The main hydraulic circuit 100 is a closed circuit which includes the traveling hydraulic pump 10, the hydraulic motor 20, and a hydraulic supply line 10a and a hydraulic supply line 10b which connect the traveling hydraulic pump 10 and the hydraulic motor 20. That is, the main hydraulic circuit 100 is a closed circuit formed between the traveling hydraulic pump 10 and the hydraulic motor 20 through the hydraulic supply line 10a and the hydraulic supply line 10b which are hydraulic lines. The traveling hydraulic pump 10 is a device which is driven by the engine 4 and discharges hydraulic oil. In the embodiment, the traveling hydraulic pump 10 is, for example, a variable displacement pump whose displacement can be changed by changing the swash plate tilt angle. A method for changing the displacement of the traveling hydraulic pump 10 is not limited to changing the swash plate tilt angle.

The hydraulic motor 20 is driven by hydraulic oil discharged from the traveling hydraulic pump 10. The hydraulic motor 20 is, for example, a variable displacement hydraulic motor which includes a swash plate 20S and a displacement thereof can be changed by changing a swash plate tilt angle. A method for changing the displacement of the hydraulic motor 20 is not limited to changing the swash plate tilt angle. The hydraulic motor 20 may be a fixed displacement hydraulic motor. The output shaft 20a of the hydraulic motor 20 is connected to the driving wheel 2a through the transfer 20b. The hydraulic motor 20 causes the forklift 1 to travel by driving the driving wheel 2a through the transfer 20b.

A rotation direction of the hydraulic motor 20 can be switched according to a supply direction of the hydraulic oil discharged from the traveling hydraulic pump 10. The forklift 1 moves forward or backward by switching the rotation direction of the hydraulic motor 20. In the following description, for convenience sake, the forklift 1 moves forward when the hydraulic oil is supplied to the hydraulic motor 20 through the hydraulic supply line 10a and moves backward when the hydraulic oil is supplied to the hydraulic motor 20 through the hydraulic supply line 10b.

The traveling hydraulic pump 10 includes an A port 10A which is a part connected to the hydraulic supply line 10a and a B port 10B which is a part connected to the hydraulic supply line 10b. When the forklift 1 moves forward, the A port 10A serves as a discharge side of the hydraulic oil, and the B port 10B serves as an inflow side of the hydraulic oil. When the forklift 1 moves backward, the A port 10A serves as the inflow side of the hydraulic oil, and the B port 10B serves as the discharge side of the hydraulic oil.

<Pump Displacement Setting Unit 11>

The forklift 1 includes a pump displacement setting unit 11, a motor displacement setting unit 21, and the charge pump 15. The pump displacement setting unit 11 is provided in the traveling hydraulic pump 10. The pump displacement setting unit 11 is provided with a forward pump proportional control solenoid valve 12, a reverse pump proportional control solenoid valve 13, and a pump displacement control cylinder 14. In the pump displacement setting unit 11, a command signal is applied to the forward pump proportional control solenoid valve 12 and the reverse pump proportional control solenoid valve 13 from a control device 30 (described below). Upon application of the command signal, the forward pump proportional control solenoid valve 12 and the reverse pump proportional control solenoid valve 13 supply hydraulic oil to the pump displacement control cylinder 14 or discharge hydraulic oil from the pump displacement control cylinder 14 to actuate the pump displacement control cylinder 14. In the pump displacement setting unit 11, the displacement of the traveling hydraulic pump 10 is changed when the pump displacement control cylinder 14 is actuated in accordance with the command signal applied from the control device 30 and the swash plate tilt angle of the traveling hydraulic pump 10 is changed.

The forward pump proportional control solenoid valve 12 and the reverse pump proportional control solenoid valve 13 actuate the pump displacement control cylinder 14 by actuating the forward pump proportional control solenoid valve 12 and the reverse pump proportional control solenoid valve 13 in accordance with the command signal applied from the control device 30 through signal lines 12c, 13c. The displacement of the traveling hydraulic pump 10 is changed by the actuation of the pump displacement control cylinder 14.

The pump displacement control cylinder 14 includes a cylinder case 14C and a piston 14a which is housed in the cylinder case 14C. The piston 14a reciprocates inside the cylinder case 14C by supply or discharge of hydraulic oil to or from a space between the cylinder case 14C and the piston 14a. In the pump displacement control cylinder 14, the piston 14a is held at a neutral position when the swash plate tilt angle is zero. Thus, even when the engine 4 rotates, the amount of hydraulic oil discharged from the traveling hydraulic pump 10 to the hydraulic supply line 10a or the hydraulic supply line 10b of the main hydraulic circuit 100 is zero.

<Motor Displacement Setting Unit 21>

The motor displacement setting unit 21 is provided in the hydraulic motor 20. The motor displacement setting unit 21 is provided with a motor proportional control solenoid valve 22, a motor cylinder control valve 23, and a motor displacement control cylinder 24. In the motor displacement setting unit 21, when a command signal is applied to the motor proportional control solenoid valve 22 from the control device 30, a motor control pressure is supplied from the motor proportional control solenoid valve 22 to the motor cylinder control valve 23, so that the motor displacement control cylinder 24 is actuated. When the motor displacement control cylinder 24 is actuated, the swash plate tilt angle of the hydraulic motor 20 is changed in cooperation with the movement of the motor displacement control cylinder 24. Thus, the displacement of the hydraulic motor 20 is changed in accordance with the command signal from the control device 30. Specifically, in the motor displacement setting unit 21, the swash plate tilt angle of the hydraulic motor 20 decreases as the motor control pressure supplied from the motor proportional control solenoid valve 22 increases.

The motor proportional control solenoid valve 22 actuates the motor cylinder control valve 23 by actuating the motor proportional control solenoid valve 22 in accordance with the command signal applied from the control device 30 through a signal line 22c, so that the motor displacement control cylinder 24 is actuated. When the motor displacement control cylinder 24 is actuated, the displacement of the hydraulic motor 20 is changed.

The charge pump 15 is driven by the engine 4. The charge pump 15 supplies a pump control pressure to the pump displacement control cylinder 14 through the forward pump proportional control solenoid valve 12 and the reverse pump proportional control solenoid valve 13 described above. The charge pump 15 supplies the motor control pressure to the motor cylinder control valve 23 through the motor proportional control solenoid valve 22.

In the embodiment, the engine 4 drives the work device hydraulic pump 16 in addition to the traveling hydraulic pump 10. The work device hydraulic pump 16 supplies hydraulic oil to the lift cylinder 7 and the tilt cylinder 8 which are working actuators for driving the work device 5.

<Relief Valve 45>

The main hydraulic circuit 100 includes a relief valve 45. The relief valve 45 is disposed between the hydraulic supply line 10a and the hydraulic supply line 10b which connect the traveling hydraulic pump 10 and the hydraulic motor 20. Specifically, the relief valve 45 is disposed between a first coupling line 10c and a second coupling line 10d which connect the hydraulic supply line 10a and the hydraulic supply line 10b. An entrance 45i of the relief valve 45 is connected to the first coupling line 10c, and an exit 45e of the relief valve 45 is connected to the second coupling line 10d. In this manner, the relief valve 45 is installed in the hydraulic supply line 10a and the hydraulic supply line 10b through the first coupling line 10c and the second coupling line 10d. The relief valve 45 sets a circuit pressure of the hydraulic line which constitutes the main hydraulic circuit 100.

A check valve 50 and a check valve 51 are attached to the first coupling line 10c. The check valve 50 allows hydraulic oil to flow from the hydraulic supply line 10a to the hydraulic supply line 10b. The check valve 51 allows hydraulic oil to flow from the hydraulic supply line 10b to the hydraulic supply line 10a. The entrance 45i of the relief valve 45 is connected between the check valve 50 and the check valve 51.

A check valve 52 and a check valve 53 are attached to the second coupling line 10d. The check valve 52 allows hydraulic oil to flow from the hydraulic supply line 10b to the hydraulic supply line 10a. The check valve 53 allows hydraulic oil to flow from the hydraulic supply line 10a to the hydraulic supply line 10b. The exit 45e of the relief valve 45 is connected between the check valve 52 and the check valve 53.

The relief valve 45 discharges hydraulic oil inside the main hydraulic circuit 100 between the traveling hydraulic pump 10 and the hydraulic motor 20. Specifically, in the relief valve 45, when a relief pressure which is a previously set pressure acts, the entrance 45i and the exit 45e are connected, and hydraulic oil flows from the entrance 45i to the exit 45e. The relief pressure is a pressure when the relief valve 45 discharges the hydraulic oil. The relief valve 45 is capable of changing the relief pressure.

The relief valve 45 includes an elastic member 45S for determining the relief pressure. When a force generated by the pressure of hydraulic oil acting on the relief valve 45 from the entrance 45i becomes larger than a force generated by the elastic member 45S, the relief valve 45 is opened. That is, the entrance 45i and the exit 45e are connected. A pressure with which the relief valve 45 is opened is the relief pressure. The relief pressure is changed by changing the force generated by the elastic member 45S by an adjustment device 46. In the embodiment, the elastic member 45S is a spring which generates a restitution force when compressed. The force generated by the elastic member 45S is changed by changing the length of the spring as the elastic member 45S by the adjustment device 46.

In the embodiment, the adjustment device 46 is a solenoid valve. The adjustment device 46 is controlled by the control device 30. Hydraulic oil is supplied to the adjustment device 46 from the charge pump 15 though an oil passage 15a. The adjustment device 46 operates in two states including a first state and a second state. In the adjustment device 46, the hydraulic oil supplied from the charge pump 15 is supplied to the relief valve 45 in the first state, and the hydraulic oil supplied from the charge pump 15 passes by in the second state. In a state where the hydraulic oil is supplied from the adjustment device 46 to the relief valve 45, the elastic member 45S has a first length. In a state where the hydraulic oil is not supplied from the adjustment device 46 to the relief valve 45, the elastic member 45S does not receive a force by the pressure of the hydraulic oil. Thus, the length of the elastic member 45S is changed to a second length which is longer than the first length. The force generated by the elastic member 45S becomes smaller when in the first length than when in the second length. Thus, a first pressure which is a relief pressure corresponding to the first length is higher than a second pressure which is a relief pressure corresponding to the second length, and the second pressure is lower than the first pressure. In this manner, the relief pressure of the relief valve 45 is changed in two steps.

When the pressure of hydraulic oil inside the hydraulic supply line 10a becomes higher than the pressure of hydraulic oil inside the hydraulic supply line 10b and becomes equal to or higher than the relief pressure of the relief valve 45, the relief valve 45 is opened. Then, the hydraulic oil in the hydraulic supply line 10a flows to the hydraulic supply line 10b through the first coupling line 10c, the check valve 50, the relief valve 45, the second coupling line 10d, and the check valve 53, and is discharged. When the pressure of hydraulic oil inside the hydraulic supply line 10b becomes higher than the pressure of hydraulic oil inside the hydraulic supply line 10a and becomes equal to or higher than the relief pressure of the relief valve 45, the relief valve 45 is opened. Then, the hydraulic oil in the hydraulic supply line 10b flows to the hydraulic supply line 10a through the first coupling line 10c, the check valve 51, the relief valve 45, the second coupling line 10d, and the check valve 52, and is discharged. The relief valve 45 prevents an excessive rise in the pressure of hydraulic oil at the entrance side and the exit side of the traveling hydraulic pump 10 and the hydraulic motor 20 by such an operation.

In the embodiment, the relief pressure of the relief valve 45 is changed according to an operation state of the inching pedal 40a. Further, in the embodiment, the relief pressure of the relief valve 45 is changed according to at least either a state of an electrical system between the control device 30 and the traveling hydraulic pump 10 or a state of an electrical system between the control device 30 and the hydraulic motor 20. In the embodiment, the relief pressure during operation of the forklift 1 is normally the first pressure and changed to the second pressure when a relief pressure change condition is satisfied. The relief pressure is changed from the second pressure to the first pressure when the condition for releasing the change of the relief pressure is satisfied after the change to the second pressure.

<Sensors of Forklift 1>

The forklift 1 is provided with an inching potentiometer (brake potentiometer) 40 which is a braking device operation amount detector, an accelerator potentiometer 41 which is an accelerator operation amount detector, a forward/reverse lever switch 42 which is a traveling direction indication detector, an engine speed sensor 43r, and a vehicle speed sensor 43v.

When the inching pedal 40a is operated, the inching potentiometer 40 detects and outputs an operation amount thereof. The operation amount of the inching pedal 40a is an inching operation amount Is. The inching operation amount Is output by the inching potentiometer 40 is input to the control device 30. In the following description, the inching operation amount Is may also be referred as an inching stroke Is.

When the accelerator pedal 41a is operated, the accelerator potentiometer 41 outputs an operation amount Aop of the accelerator pedal 41a. The operation amount Aop of the accelerator pedal 41a is also referred to as an accelerator opening Aop. The accelerator opening Aop output by the accelerator potentiometer 41 is input to the control device 30.

The forward/reverse lever switch 42 is a selection switch for switching the traveling direction of the forklift 1. The present embodiment employs the forward/reverse lever switch 42 which is capable of switching between forward and backward movements of the forklift 1 by selecting one of three traveling directions including forward, neutral, and reverse by operating the forward/reverse lever 42a which is disposed at a position that can be selectively operated from the driver's seat. Information indicating the traveling direction of the forklift 1 selected by the forward/reverse lever switch 42 is provided to the control device 30 as selection information. The traveling direction of the forklift 1 selected by the forward/reverse lever switch 42 includes both a direction in which the forklift 1 is going to travel and a direction in which the forklift 1 is actually traveling.

The engine speed sensor 43r detects an actual speed of the engine 4. The speed of the engine 4 detected by the engine speed sensor 43r is an actual engine speed Nr. Information indicating the actual engine speed Nr is input to the control device 30. The speed of the engine 4 is the number of revolutions of the output shaft 4S of the engine 4 per unit time. The vehicle speed sensor 43v is a device which detects an actual vehicle speed Vc which is a speed when the forklift 1, that is, the traveling device travels.

<Control Device 30>

The control device 30 includes a processing unit 30C and a storage unit 30M. The control device 30 is a device which is provided with, for example, a computer and executes various processes relating to the control of the forklift 1. The processing unit 30C is, for example, a device which is a combination of a processor such as a central processing unit (CPU) and a memory. The processing unit 30C reads a computer program for controlling the main hydraulic circuit 100 which is stored in the storage unit 30M and executes a command described in the computer program to control the operation of the main hydraulic circuit 100. The storage unit 30M stores, for example, the above computer program and data required for the control of the main hydraulic circuit 100. The storage unit 30M is, for example, a read only memory (ROM), a storage device, or a device combining the ROM and the storage device.

The various sensors including the inching potentiometer 40, the accelerator potentiometer 41, the forward/reverse lever switch 42, the engine speed sensor 43r, and the vehicle speed sensor 43v are electrically connected to the control device 30. The control device 30 generates command signals for the forward pump proportional control solenoid valve 12, the reverse pump proportional control solenoid valve 13, the motor proportional control solenoid valve 22, and the adjustment device 46 on the basis of input signals from these various sensors. The control device 30 applies the generated command signals to the forward pump proportional control solenoid valve 12, the reverse pump proportional control solenoid valve 13, the motor proportional control solenoid valve 22, and the adjustment device 46.

Power is supplied to the control device 30 from a power source 44 through an electric wire 44W. The control device 30 operates with the power supplied from the power source 44. A secondary battery mounted on the forklift 1 is an example of the power source 44.

<Control During Braking>

Next, control of the forklift 1 during braking will be described. When an operator of the forklift 1 depresses the inching pedal 40a, the inching potentiometer 40 detects an operation state of the inching pedal 40a and provides the operation state to the control device 30. Examples of the operation state of the inching pedal 40a include, but not limited to, an operation amount and an operation speed of the inching pedal 40a.

The control device 30 reduces a flow rate of the traveling hydraulic pump 10 on the basis of the operation state of the inching pedal 40a received from the inching potentiometer 40. When the flow rate of the traveling hydraulic pump 10 is reduced, a flow rate of the hydraulic motor 20 becomes larger than the flow rate of the traveling hydraulic pump 10, and the forklift 1 is thus decelerated. Simultaneously, the mechanical brakes 9F, 9R generate a braking force.

When an operator suddenly depresses the inching pedal 40a, for example, in an emergency, a rotation speed of the driving wheel 2a and a rotation speed of the hydraulic motor 20 are suddenly reduced by the mechanical brakes 9F, 9R. Thus, the speed of reducing the flow rate of the traveling hydraulic pump 10 may not catch up with the decrease in the rotation speed of the hydraulic motor 20. That is, during braking, a response of the traveling hydraulic pump 10 may be delayed. As a result, the flow rate of the traveling hydraulic pump 10 instantaneously becomes excessive relative to the flow rate of the hydraulic motor 20, and the pressure of hydraulic oil suddenly rises between the discharge side of the traveling hydraulic pump 10 and the inflow side of the hydraulic motor 20. Sine there is also a response delay of the relief valve 45, the pressure of hydraulic oil present between the discharge side of the traveling hydraulic pump 10 and the inflow side of the hydraulic motor 20 inside the main hydraulic circuit 100 may excessively rise.

During braking, in order to prevent an excessive rise in the pressure of hydraulic oil present between the discharge side of the traveling hydraulic pump 10 and the inflow side of the hydraulic motor 20, the relief pressure of the relief valve 45 is changed according to an operation state of the inching pedal 40a. Specifically, when the inching pedal 40a is in an operation state indicating sudden braking, the relief pressure is changed from the first pressure to the second pressure which is lower than the first pressure. The change is performed by the control device 30.

The control device 30 determines an operation state of the inching pedal 40a from the detection result of the inching potentiometer 40. When the operation state of the inching pedal 40a indicates sudden braking, the control device 30 generates a command value for bringing the adjustment device 46 into the second state and provides the command value to the adjustment device 46. The adjustment device 46 is changed from the first state to the second state upon receiving the command. Thus, the relief pressure is changed from the first pressure to the second pressure. Accordingly, since the relief valve 45 is opened with the second pressure which is lower than the first pressure, hydraulic oil is discharged from a part between the discharge side of the traveling hydraulic pump 10 and the inflow side of the hydraulic motor 20 to a part between the inflow side of the traveling hydraulic pump 10 and the discharge side of the hydraulic motor 20. This prevents an excessive rise in the pressure of hydraulic oil inside the main hydraulic circuit 100, specifically, hydraulic oil present between the discharge side of the traveling hydraulic pump 10 and the inflow side of the hydraulic motor 20.

When the operation state of the inching pedal 40a does not indicate sudden braking, the adjustment device 46 is in the first state, and the relief pressure is thus the first pressure which is higher than the second pressure. Thus, when the forklift 1 is not in a sudden braking state, but in a normal state, the possibility of a reduction in acceleration and traction of the forklift 1 caused by the opening of the relief valve 45 is reduced.

In order to start control during braking, it is necessary to apply a braking operation, that is, an operation for causing the mechanical brakes 9F, 9R to generate a braking force to the inching pedal 40a. In the embodiment, in addition to the application of the braking operation to the inching pedal 40a, the relief pressure is changed from the first pressure Prh to the second pressure Prl or is maintained at the first pressure Prh according to an operation state of the inching pedal 40a. In order to change the relief pressure from the first pressure Prh to the second pressure Prl, it is at least necessary to apply a braking operation to the inching pedal 40a.

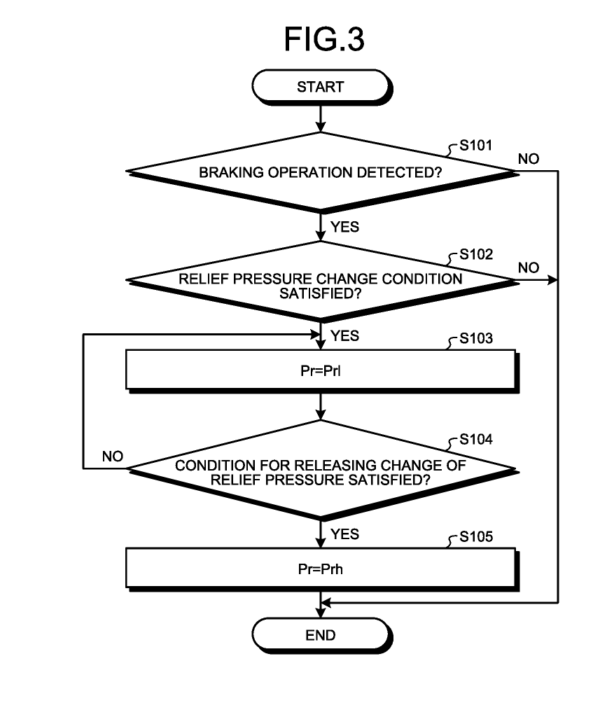

FIG. 3 is a flowchart illustrating a control example of the forklift 1 during braking. When the control device 30 has detected a braking operation from the inching potentiometer 40 in step S101 (Yes in step S101), the control device 30 determines whether the relief pressure change condition is satisfied in step S102. When the control device 30 has detected no braking operation from the inching potentiometer 40 (No in step S101), the control during braking is finished.

In the embodiment, when all the following five conditions are satisfied, the relief pressure change condition is determined to be satisfied. In the condition (5), “in shuttle” indicates a state in which the direction of the forward/reverse lever 42a differs from a traveling direction of the forklift 1. The condition (5) is not satisfied when the forward/reverse lever 42a is in a reverse state, but the forklift 1 moves forward.

(1) The operation amount of the inching pedal 40a, that is, the inching stroke Is before the determination time by a first time is less than a first threshold which is a predetermined threshold.

(2) An increasing speed of the inching stroke Is more than a second threshold which is a predetermined threshold.

(3) The inching stroke Is at the determination time is more than a third threshold which is a predetermined threshold.

(4) The actual vehicle speed Vc of the forklift 1 is more than a fourth threshold which is a predetermined threshold.

(5) The forward/reverse lever 42a is at the reverse side, and not in shuttle.

When the relief pressure change condition is satisfied (Yes in step S102), the control device 30 changes the relief pressure Pr to the second pressure Prl in step S103. In the embodiment, the control device 30 changes the relief pressure Pr to the second pressure Prl by bringing the adjustment device 46 into the second state. When the relief pressure change condition is not satisfied (No in step S102), the control during braking is finished.

In step S104, the control device 30 determines whether the condition for releasing the change of the relief pressure is satisfied. In the embodiment, when at least one of the following two conditions is satisfied, the condition for releasing the change of the relief condition is determined to be satisfied. The condition (A) means that a reduced state of the operation amount of a braking operation applied to the inching pedal 40a has continued for a predetermined time. The condition (B) is satisfied when the forward/reverse lever 42a is in a reverse state, but the forklift 1 moves forward.

(A) A state in which the inching stroke Is is less than the third threshold continues for a second time which is a predetermined time.

(B) The forward/reverse lever 42a is at the reverse side, and in shuttle.

When the condition for releasing the change of the relief pressure is satisfied (Yes in step S104), the control device 30 changes the relief pressure Pr to the first pressure Prh in step S105. In the embodiment, the control device 30 changes the relief pressure Pr to the first pressure Prh by bringing the adjustment device 46 into the first state. Thereafter, the control during braking is finished.

During braking, the control device 30 executes the above control to thereby reduce the possibility of occurrence of an excessive pressure rise in hydraulic oil present inside the main hydraulic circuit 100, specifically, present between the discharge side of the traveling hydraulic pump 10 and the inflow side of the hydraulic motor 20. In the embodiment, the relief pressure change condition is satisfied when all the conditions (1) to (5) are satisfied. However, whether braking is sudden braking can be determined only from the operation state of the inching pedal 40a. Thus, the control device 30 may determine that the relief pressure change condition is satisfied when all the conditions (1), (2) and (3) which are conditions relating to the operation state of the inching pedal 40a are satisfied.

When the actual vehicle speed Vc of the forklift 1 is higher, the flow rate of the traveling hydraulic pump 10 becomes larger, and a difference from the flow rate of the hydraulic motor 20 when the driving wheel 2a is locked at the time of sudden braking becomes larger. Thus, when the relief valve 45 is not opened, a pressure rise between the discharge side of the traveling hydraulic pump 10 and the inflow side of the hydraulic motor 20 becomes larger. Further, when the actual vehicle speed Vc of the forklift 1 is lower, the flow rate of the traveling hydraulic pump 10 becomes smaller, and the difference from the flow rate of the hydraulic motor 20 when the driving wheel 2a is locked at the time of sudden braking becomes smaller. Thus, a pressure rise between the discharge side of the traveling hydraulic pump 10 and the inflow side of the hydraulic motor 20 which occurs when the relief valve 45 is not opened may be allowable.

The condition (4) reduces the relief pressure so as to be smaller than that before the application of a braking operation by changing the relief pressure Pr from the first pressure Prh to the second pressure Prl when a traveling speed of the forklift 1 is equal to or more than the fourth threshold which is a predetermined threshold. The relief pressure is changed taking the traveling speed of the forklift 1 into consideration by adding the condition (4) to the relief pressure change condition. Thus, frequent changes of the relief pressure to the second pressure Prl are prevented. When the relief pressure is frequently changed to the second pressure Prl, the acceleration and the traction of the forklift 1 may be reduced by the opening of the relief valve 45. However, this possibility can be reduced by the condition (4).

In the embodiment, the driving wheel 2a serves as the front wheel of the forklift 1. Thus, a large load acts on the driving wheel 2a in braking during forward movement, which makes the driving wheel 2a less likely to slip. As a result, even when sudden braking occurs during forward movement, the possibility of the driving wheel 2a being locked by the mechanical brake 9F is reduced. Thus, the speed of reducing the flow rate of the traveling hydraulic pump 10 catches up with a decrease in the rotation speed of the hydraulic motor 20 in many cases. The condition (5) is a condition for changing the relief pressure Pr from the first pressure Prh to the second pressure Prl when the forklift 1 travels rearward. According to the condition (5), since the relief pressure Pr is maintained at the first pressure when it is not necessary to change the relief pressure to the second pressure Prh, the possibility of a reduction in the acceleration and the traction of the forklift 1 caused by the opening of the relief valve 45 can be reduced.

Variations in the specification of the forklift 1 result in variations in a condition for delay in the response of the traveling hydraulic pump 10 during sudden braking. Thus, the condition (5) may not be added to the relief pressure change condition according to the specification of the forklift 1 or contents of the condition (5) may be changed. The condition (B) included in the condition for releasing the change of the relief pressure corresponds to the condition (5) of the relief pressure change condition. Thus, the condition (B) may also be not added to the relief pressure change condition according to the specification of the forklift 1 or contents of the condition (B) may be changed.

When the sudden braking state is released, it is necessary to return the relief pressure Pr to the first pressure Prh. Whether the sudden braking state has been released is determined by a decrease in the operation amount of the braking operation to the inching pedal 40a. When the relief pressure Pr is changed from the second pressure Prl to the first pressure Prh, the hydraulic oil is going to flow through the relief valve 45, but the relief valve 45 is going to be closed. Thus, the pressure of hydraulic oil at the side of the entrance 45i of the relief valve 45 may suddenly rise. Thus, when the relief pressure is returned to the first pressure Prh immediately after the release of the sudden braking state, the pressure of hydraulic oil present between the side of the entrance 45i of the relief valve 45, that is, the discharge side of the traveling hydraulic pump 10 and the inflow side of the hydraulic motor 20 may suddenly rise.

The relief pressure Pr is changed from the second pressure Prl to the first pressure Prh after continuation of a reduced state of the operation amount of the braking operation applied to the inching pedal 40a for the second time by the addition of the condition (A) to the condition for releasing the change of the relief pressure. When the sudden braking state is released, the relief valve 45 is closed after a reduction in the flow rate of hydraulic oil flowing through the relief valve 45 by the condition (A). This reduces the possibility of a sudden rise in the pressure of hydraulic oil present between the discharge side of the traveling hydraulic pump 10 and the inflow side of the hydraulic motor 20.

<Control Under Abnormal Electrical System Condition>

Next, control under an abnormal condition of the electrical system between the control device 30 and the main hydraulic circuit 100 will be described. The electrical system of the main hydraulic circuit 100 includes a first system which is the electrical system between the control device 30 and the traveling hydraulic pump 10 and a second system which is the electrical system between the control device 30 and the hydraulic motor 20.

The control device 30 controls the traveling hydraulic pump 10 by applying a command signal which is an electric signal to the forward pump proportional control solenoid valve 12 and the reverse pump proportional control solenoid valve 13 through the signal lines 12c, 13c. The first system includes the control device 30, the signal lines 12c, 13c, and electric circuits included in the forward pump proportional control solenoid valve 12 and the reverse pump proportional control solenoid valve 13.

The control device 30 controls the hydraulic motor 20 by applying a command signal which is an electric signal to the motor proportional control solenoid valve 22 through the signal line 22c. The second system includes the control device 30, the signal line 22c, and an electric circuit included in the motor proportional control solenoid valve 22.

For example, when there are a break and a ground fault in at least either the signal line 12c or the signal line 13c of the first system, at least either the forward pump proportional control solenoid valve 12 or the reverse pump proportional control solenoid valve 13 fails to operate. As a result, the swash plate 10S of the traveling hydraulic pump 10 is closed, and the flow rate of hydraulic oil discharged from the traveling hydraulic pump 10 is suddenly reduced. When there are a break and a ground fault in the signal line 22c of the second system, the swash plate 20S of the hydraulic motor 20 is closed, and the flow rate of hydraulic oil flowing into the hydraulic motor 20 is suddenly reduced. Accordingly, the forklift 1 is suddenly decelerated. The sudden deceleration of the forklift 1 may result in a load collapse.

When the flow rate of the traveling hydraulic pump 10 or the hydraulic motor 20 is suddenly reduced, the pressure of hydraulic oil between the inflow side of the traveling hydraulic pump 10 and the discharge side of the hydraulic motor 20 suddenly rises. As a result, the forklift 1 is suddenly decelerated. The control device 30 changes the relief pressure Pr according to at least either a state of the first system or a state of the second system. The control device 30 changes the relief pressure Pr from the first pressure Prh to the second pressure Prl, for example, when detecting a break and a ground fault in at least either the signal line 12c or the signal line 13c of the first system or detecting a break and a ground fault in the signal line 22c of the second system.

When the relief pressure Pr drops to the second pressure Prl, the relief valve 45 becomes easy to open as compared to the case of the first pressure Prh. When the relief valve 45 is opened by the drop of the relief pressure Pr to the second pressure Prl, the hydraulic oil present between the inflow side of the traveling hydraulic pump 10 and the discharge side of the hydraulic motor 20 is discharged to the part between the discharge side of the traveling hydraulic pump 10 and the inflow side of the hydraulic motor 20 through the relief valve 45. As a result, a sudden rise in the pressure of hydraulic oil present between the inflow side of the traveling hydraulic pump 10 and the discharge side of the hydraulic motor 20 is prevented. Thus, a sudden deceleration of the forklift 1 is prevented.

In the embodiment, the adjustment device 46 becomes the second state when the control device 30 is turned OFF. When the electric wire 44W between the control device 30 and the power source 44 is broken, the control device 30 is turned OFF, and the adjustment device 46 thus becomes the second state. Accordingly, the relief pressure becomes the second pressure Prl, and the relief valve 45 thus becomes easy to open as compared to the case of the first pressure Prh. When the relief valve 45 is opened by the drop of the relief pressure Pr to the second pressure Prl, the hydraulic oil present between the inflow side of the traveling hydraulic pump 10 and the discharge side of the hydraulic motor 20 is discharged to the part between the discharge side of the traveling hydraulic pump 10 and the inflow side of the hydraulic motor 20 through the relief valve 45. As a result, a sudden rise in the pressure of hydraulic oil present between the inflow side of the traveling hydraulic pump 10 and the discharge side of the hydraulic motor 20 is prevented. Thus, a sudden deceleration of the forklift 1 is reduced.

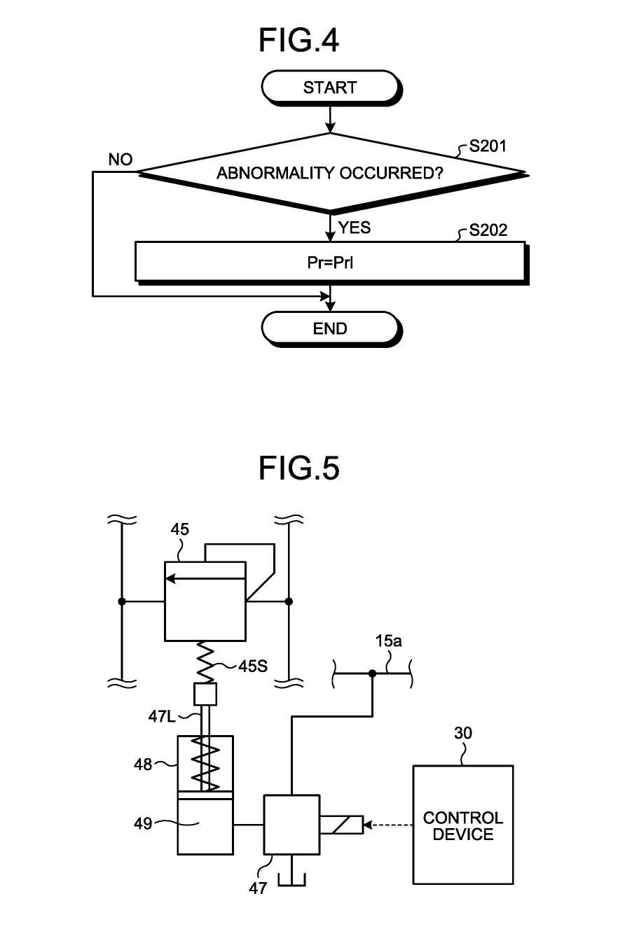

FIG. 4 is a flowchart illustrating a processing example under an abnormal condition of the electrical system. When the control device 30 has detected an abnormality, for example, at least either a fault ground or a break in at least either the first system or the second system in step S201 (Yes in step S201), the control device 30 changes the relief pressure Pr to the second pressure Prl in step S202. When the control device 30 has detected no abnormality in at least either the first system or the second system (No in step S201), the control device 30 finishes the processing.

The control device 30 is capable of preventing a sudden deceleration of the forklift 1 by changing the relief pressure Pr to the second pressure Prl when there is an abnormality in at least either the first system or the second system.

<Example of Steplessly Changing Relief Pressure Pr>

FIG. 5 is a diagram illustrating an example of steplessly changing the relief pressure Pr of the relief valve 45. In the above description, the relief pressure Pr of the relief valve 45 can be changed in two steps, specifically, the first pressure Prh or the second pressure Prl. Alternatively, the relief pressure Pr may be steplessly changed. In the relief valve 45, the length of the elastic member 45S is steplessly changed by a pressure change cylinder 48 which is driven by a proportional control solenoid valve 47. As a result, the relief pressure Pr is steplessly changed.

Hydraulic oil discharged from the charge pump 15 illustrated in FIG. 2 is supplied to the proportional control solenoid valve 47 through the oil passage 15a. When a command signal is applied to the proportional control solenoid valve 47 from the control device 30, the proportional control solenoid valve 47 supplies the hydraulic oil supplied through the oil passage 15a to the pressure change cylinder 48 or discharges hydraulic oil from the pressure change cylinder 48 to actuate the pressure change cylinder 48.

When the hydraulic oil is discharged from a cylinder chamber 49 of the pressure change cylinder 48, a piston rod 47L which is coupled to the elastic member 45S moves away from the relief valve 45, and the elastic member 45S thus becomes longer. As a result, the relief pressure Pr decreases. When the hydraulic oil is supplied to the cylinder chamber 49 of the pressure change cylinder 48, the piston rod 47L which is coupled to the elastic member 45S moves close to the relief valve 45, and the elastic member 45S thus becomes shorter. As a result, the relief pressure Pr rises.

Since the relief pressure Pr of the relief valve 45 can be steplessly changed, the control device 30 is capable of steplessly changing the relief pressure Pr according to the operation state of the inching pedal 40a. For example, the control device 30 is capable of finely adjusting the second pressure Prl taking the temperature of hydraulic oil into consideration and also capable of changing the second pressure Prl according to the operation amount and the operation speed of the inching pedal 40a. As a result, the control device 30 can achieve appropriate and precise control as compared to the case when the relief pressure Pr is changed in two steps.

Although the embodiment has been described above, the embodiment is not limited by the above description. The elements described above include elements that are easily conceivable by a person skilled in the art and substantially the same elements, that is, elements in the range of equivalency. Further, the above elements can be appropriately combined. Further, at least one of various omissions, replacements, and changes of the elements can be performed without departing from the gist of the embodiment. The work machine is not limited to a forklift, and may be a wheel loader, a grader, a bulldozer, or a dump truck. The traveling hydraulic pump 10 and the hydraulic motor 20 may not be a variable displacement pump and a variable displacement motor.

### REFERENCE SIGNS LIST

1 FORKLIFT
2a DRIVING WHEEL
4 ENGINE
5 WORK DEVICE
6 FORK
9F, 9R MECHANICAL BRAKE
10 TRAVELING HYDRAULIC PUMP
12 FORWARD PUMP PROPORTIONAL CONTROL SOLENOID VALVE
13 REVERSE PUMP PROPORTIONAL CONTROL SOLENOID VALVE
11 PUMP DISPLACEMENT SETTING UNIT
12c, 13c, 22c SIGNAL LINE
14 PUMP DISPLACEMENT CONTROL CYLINDER
15 CHARGE PUMP
16 WORK DEVICE HYDRAULIC PUMP
20 HYDRAULIC MOTOR
21 MOTOR DISPLACEMENT SETTING UNIT
22 MOTOR PROPORTIONAL CONTROL SOLENOID VALVE
23 MOTOR CYLINDER CONTROL VALVE
24 MOTOR DISPLACEMENT CONTROL CYLINDER
30 CONTROL DEVICE
30C PROCESSING UNIT
30M STORAGE UNIT
40 INCHING POTENTIOMETER
40MS MASTER CYLINDER
40a INCHING PEDAL
42 FORWARD/REVERSE LEVER SWITCH
42a FORWARD/REVERSE LEVER
45 RELIEF VALVE
45e EXIT
45i ENTRANCE
45S ELASTIC MEMBER
46 ADJUSTMENT DEVICE
47 PROPORTIONAL CONTROL SOLENOID VALVE
48 PRESSURE CHANGE CYLINDER
100 MAIN HYDRAULIC CIRCUIT
Pr RELIEF PRESSURE
Prh FIRST PRESSURE
Prl SECOND PRESSURE

1. A work machine comprising:
a relief valve that is installed in a hydraulic line that forms a closed circuit between a hydraulic pump and a hydraulic motor, and sets a relief pressure of the hydraulic line;
a braking device that brakes a traveling device attached to the hydraulic motor; and
an operation mechanism that operates the braking device, wherein
when a traveling speed of the traveling device is equal to or more than a predetermined threshold, the relief pressure is changed from a first pressure that is a pressure before a braking operation is performed by the operation mechanism to a second pressure that is lower than the first pressure.

2. The work machine according to claim 1, wherein the relief pressure is changed from the second pressure to the first pressure after continuation of a reduced state of an operation amount of the braking operation applied to the operation mechanism for a predetermined time.

3. A work machine comprising a relief valve that is installed in a hydraulic line that forms a closed circuit between a hydraulic pump and a hydraulic motor, and sets a relief pressure of the hydraulic line, wherein
the relief pressure is changed according to at least either a state of an electrical system between a control device that controls the hydraulic pump and the hydraulic motor and the hydraulic pump or a state of an electrical system between the control device and the hydraulic motor.

4. The work machine according to claim 3, wherein the relief valve is capable of steplessly changing the relief pressure.

5. The work machine according to claim 1, wherein the relief valve is capable of steplessly changing the relief pressure.
